(19) United States
(12) Patent Application Publication
(10) Pub. No.: US 2026/0259637 A1
(43) Pub. Date: Sep. 3, 2026

(54) INFORMATION PROCESSING METHOD, INFORMATION PROCESSING DEVICE, AND NON-TRANSITORY COMPUTER READABLE RECORDING MEDIUM STORING INFORMATION PROCESSING PROGRAM

(71) Applicant: PANASONIC INTELLECTUAL PROPERTY MANAGEMENT CO., LTD., Osaka (JP)

(72) Inventor: Seikou ABE, Osaka (JP)

(73) Assignee: PANASONIC INTELLECTUAL PROPERTY MANAGEMENT CO., LTD., Osaka (JP)

(21) Appl. No.: 19/655,437

(22) Filed: Apr. 22, 2026

Related U.S. Application Data
(63) Continuation of application No. PCT/JP2024/038774, filed on Oct. 30, 2024.
(60) Provisional application No. 63/546,977, filed on Nov. 2, 2023.

(30) Foreign Application Priority Data
Aug. 7, 2024 (JP) 2024-130804

(51) Int. Cl. G06F 3/04817; G06F 3/04842; G06T 11/10

(52) U.S. Cl. CPC G06F 3/04817; G06F 3/04842; G06T 11/10; G06T 2200/24

(57) ABSTRACT

An information processing method includes: displaying a bird’s-eye view on a display of an information terminal; displaying, in the bird’s-eye view, a photographing spot icon group indicating a plurality of photographing spots being continuous in a series from a photographing start spot to a photographing finish spot; receiving, in the bird’s-eye view, selection of a certain region by the user; and extracting, in a case where the certain region includes two or more photographing spot icon groups and respective photographing positions for the two or more photographing spot icon groups are similar to each other, two or more pieces of data for the two or more photographing spot icon groups similar to each other.

### FIELD OF INVENTION

The present disclosure relates to a technology of displaying an image.

### BACKGROUND ART

For instance, Patent Literature 1 discloses a technology of specifying a range from a desired first position to a desired second position and displaying a main image falling within the specified range from a main image group obtained by photographing a site, and displaying, in a drawing image showing a drawing for a target site, a pointer indicating a corresponding spot on the target site shown in the main image being displayed.

Unfortunately, the conventional technology fails to disclose how to make access to two or more pieces of data for two or more desired photographing spot icon groups, and thus needs further improvement. Besides, for the access to the two or more pieces of data, the number of processing steps by a computer may increase, and hence, a burden on the computer may increase.

Patent Literature 1: Japanese Unexamined Patent Publication No. 2022-24440

### SUMMARY OF THE INVENTION

This disclosure has been accomplished to overcome the disadvantages described above, and has an object of providing a technology to enable easy access to two or more pieces of data for two or more desired photographing spot icon groups and achieve improvement in convenience for a user, and further achieve a reduction in the number of processing steps required by a computer for access to the two or more pieces of data and hence achieve a reduction in the burden on the computer.

An information processing method according to an aspect of the present disclosure is an information processing method to be executed by a computer, and includes: displaying a bird’s-eye view on a display of an information terminal; displaying, in the bird’s-eye view, a photographing spot icon group indicating a plurality of photographing spots being continuous in a series from a photographing start spot to a photographing finish spot; receiving, in the bird’s-eye view, selection of a certain region by the user; and extracting, in a case where the certain region includes two or more photographing spot icon groups and respective photographing positions for the two or more photographing spot icon groups are similar to each other, two or more pieces of data for the two or more photographing spot icon groups similar to each other.

This disclosure enables easy access to two or more pieces of data for two or more desired photographing spot icon groups, and achieves improvement in convenience for a user. The disclosure further achieves a reduction in the number of processing steps required by a computer for access to the two or more pieces of data, and hence achieves a reduction in the burden on the computer.

### BRIEF DESCRIPTION OF THE DRAWINGS

FIG. 1 is diagram showing an overall configuration of an information processing system in an embodiment.

FIG. 2 illustrates an example design drawing screen image in which a plurality of photographing spot icon groups is mapped in the embodiment.

FIG. 3 illustrates an example design drawing screen image showing a design drawing in which a region is drawn.

FIG. 4 illustrates an example captured image screen image to be displayed on a display when the region is selected in the embodiment.

FIG. 5 is a first flowchart showing an example of an image displaying process by a server in the embodiment.

FIG. 6 is a second flowchart showing an example of the image displaying process by the server in the embodiment.

### DETAILED DESCRIPTION

Knowledge forming the basis of the present disclosure

The conventional technology shows one main image group including main images in a series obtained by photographing a site, and thus fails to display, for example, a plurality of main image groups obtained through photographing at different dates and times. Moreover, the conventional technology merely displays, in a site drawing, a photographing spot for one main image in the main image group, and fails to display, in the site drawing, photographing spots respectively for main images in the main image group. Therefore, the conventional technology fails to disclose, in a case where a plurality of image groups is present, how to make access to data for a desired main image group among the main image groups. Besides, for access to two or more pieces of data, the number of processing steps by a computer may increase, and hence, a burden on the computer may increase.

The following technologies will be described to solve the disadvantages.

(1) An information processing method according to an aspect of the disclosure is an information processing method to be executed by a computer, and includes: displaying a bird’s-eye view on a display of an information terminal; displaying, in the bird’s-eye view, a photographing spot icon group indicating a plurality of photographing spots being continuous in a series from a photographing start spot to a photographing finish spot; receiving, in the bird’s-eye view, selection of a certain region by the user; and extracting, in a case where the certain region includes two or more photographing spot icon groups and respective photographing positions for the two or more photographing spot icon groups are similar to each other, two or more pieces of data for the two or more photographing spot icon groups similar to each other.

This configuration enables easy access to two or more pieces of data for the two or more desired photographing spot icon groups through selection of a region including two or more desired photographing spot icon groups in the bird’s-eye view, and thus achieves improvement in convenience for a user. The configuration further includes extracting the two or more pieces of data for the two or more photographing spot icon groups through the selection of the region including the two or more desired photographing spot icon groups in the bird’s-eye view, and thus achieves a reduction in the number of processing steps required by a computer for the access to the two or more pieces of data, and then achieves a reduction in the burden on the computer.

(2) In the information processing method according to (1) above, the extracting of the two or more pieces of data may include extracting the two or more pieces of data for the two or more photographing spot icon groups when at least one of a distance between photographing start spots respectively for the two or more photographing spot icon groups and a distance between photographing finish spots respectively for the two or more photographing spot icon groups has a threshold or lower.

In this configuration, it is determined whether at least one of a distance between photographing start spots respectively for two or more photographing spot icon groups and a distance between photographing finish spots respectively for the two or more photographing spot icon groups has a threshold or lower. This enables easy determination as to whether respective photographing positions for the two or more photographing spot icon groups are similar to each other.

(3) In the information processing method according to (1) above, the extracting of the two or more pieces of data may include extracting the two or more pieces of data for the two or more photographing spot icon groups when the two or more photographing spot icon groups overlap each other within the certain region.

In this configuration, it is determined whether two or more photographing spot icon groups overlap each other within a region. This enables easy determination as to whether respective photographing positions for the two or more photographing spot icon groups are similar to each other.

(4) In the information processing method in (1) above, the two or more photographing spot icon groups may include a first photographing spot icon group and a second photographing spot icon group, and the extracting of the two or more pieces of data may include extracting first data for the first photographing spot icon group and second data for the second photographing spot icon group when a shortest distance among distances respectively between a plurality of photographing spots for the first photographing spot icon group within the certain region and a plurality of photographing spots for the second photographing spot icon group within the certain region has a threshold or lower.

In this configuration, it is determined whether a shortest distance among distances respectively between a plurality of photographing spots for the first photographing spot icon group within a region and a plurality of photographing spots for the second photographing spot icon group within the region has a threshold or lower. This enables easy determination as to whether respective photographing positions for two or more photographing spot icon groups are similar to each other..

(5) The information processing method according to any one of (1) to (4) above may further include displaying, on the display, a name to identify the photographing spot icon group together with the bird’s-eye view.

This configuration includes displaying a name to identify the photographing spot icon group together with the bird’s-eye view, and thus allows the user to confirm the name of the photographing spot icon group.

(6) The information processing method according to (5) above may further include changing, in the case where the certain region includes the two or more photographing spot icon groups and the respective photographing positions for the two or more photographing spot icon groups are similar to each other, a display mode for the two or more photographing spot icon groups and a display mode for two or more names corresponding to the two or more photographing spot icon groups.

This configuration includes changing a display mode for two or more desired photographing spot icon groups and a display mode for two or more names corresponding to the two or more desired photographing spot icon groups through selection of a region including the two or more desired photographing spot icon groups in the bird’s-eye view, and thus allows the user to easily confirm the respective names of the two or more desired photographing spot icon groups.

(7) In the information processing method according to (6), the changing of each of the display modes may include changing a color of the two or more photographing spot icon groups, and changing a color of the two or more names to the same color as the changed color of the two or more photographing spot icon groups.

This configuration includes changing a color of two or more photographing spot icon groups, and changing a color of two or more names to the same color as the changed color of the two or more photographing spot icon groups, and thus enables easy confirmation of the names of the two or more photographing spot icon groups selected by the user.

(8) In the information processing method according to any one of (1) to (7) above, the data may include an image captured at a certain photographing spot.

In this configuration, two or more images respectively captured at two or more photographing spots for the two or more photographing spot icon groups are extracted. This enables displaying of the two or more images, and further enables comparison between the two or more images captured at photographing positions being similar to each other.

(9) In the information processing method according to any one of (1) to (8) above, the displaying of the photographing spot icon group may include displaying the photographing spot icon group in a color in connection with a photographing date and time.

This configuration includes displaying the photographing spot icon group in a color in connection with a photographing date and time, and thus allows the user to intuitively recognize the photographing date and time by confirming the color of the photographing spot icon group.

Moreover, the disclosure can be realized as: the information processing method executing the above-described distinctive ways; and a information processing device including each distinctive feature corresponding to the distinctive ways executed by the information processing method. Additionally, the disclosure can be realized by a computer program causing a computer to execute the distinctive ways included in the information processing method. From these perspectives, the same advantageous effects as those of the information processing method are achievable in the following other aspects.

(10) An information processing device according to another aspect of the present disclosure includes a processor. The processor is configured to: display a bird’s-eye view on a display of an information terminal; display, in the bird’s-eye view, a photographing spot icon group indicating a plurality of photographing spots being continuous in a series from a photographing start spot to a photographing finish spot; receive, in the bird’s-eye view, selection of a certain region by the user; and, extract, in a case where the certain region includes two or more photographing spot icon groups and respective photographing positions for the two or more photographing spot icon groups are similar to each other, two or more pieces of data for the two or more photographing spot icon groups similar to each other.

(11) An information processing program according to still another aspect of the present disclosure includes causing a computer to: display a bird’s-eye view on a display of an information terminal; display, in the bird’s-eye view, a photographing spot icon group indicating a plurality of photographing spots being continuous in a series from a photographing start spot to a photographing finish spot; receive, in the bird’s-eye view, selection of a certain region by the user; and extract, in a case where the certain region includes two or more photographing spot icon groups and respective photographing positions for the two or more photographing spot icon groups are similar to each other, two or more pieces of data for the two or more photographing spot icon groups similar to each other.

(12) A non-transitory computer readable medium according to another aspect of the present disclosure stores an information processing program described in (11) above.

An embodiment of this disclosure will be described with reference to the accompanying drawings. The embodiment which will be described below represents a specific example of the disclosure. Numeric values, shapes, constituent elements, steps, and the order of the steps described below in the embodiment are mere examples, and thus should not be construed to delimit the disclosure. Moreover, constituent elements which are not recited in the independent claims each showing the broadest concept among the constituent elements in the embodiments are described as selectable constituent elements. The respective contents are combinable with each other in all the embodiments.

### Embodiment

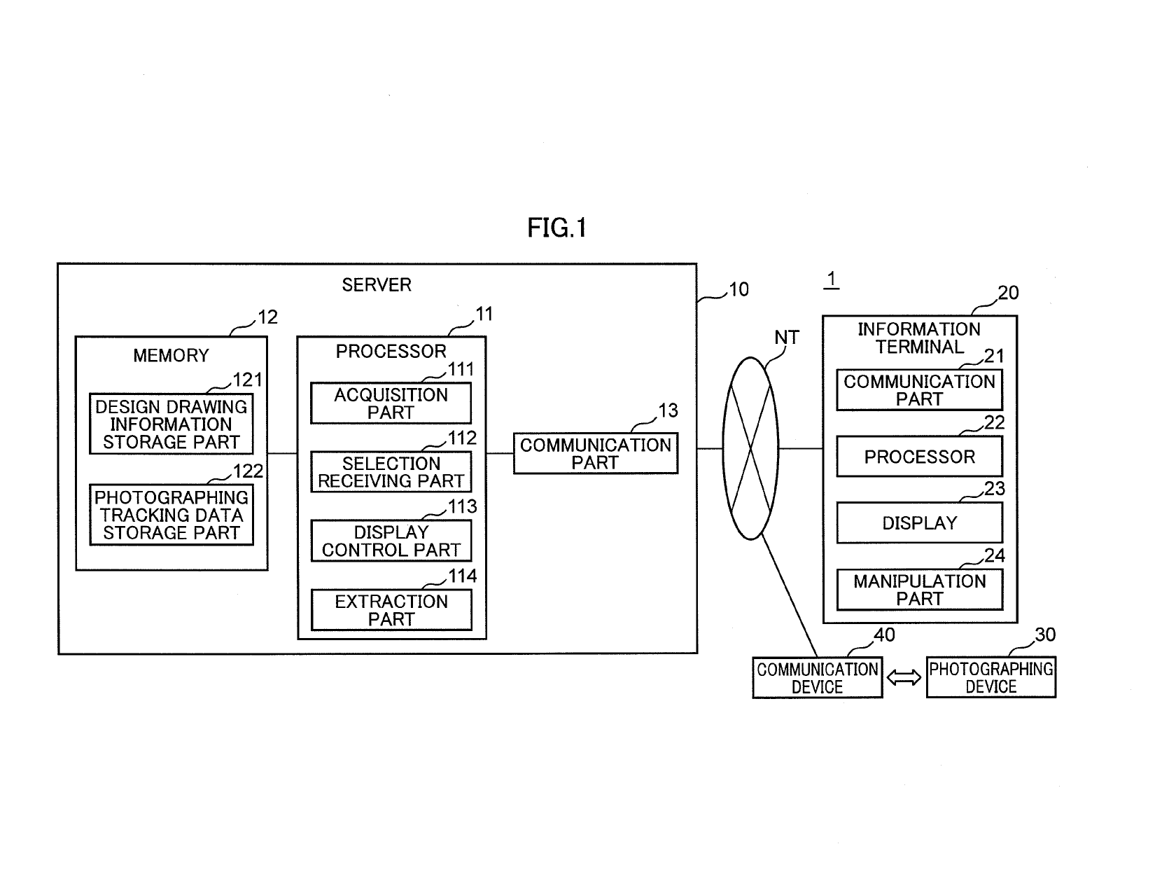

FIG. 1 is diagram showing an overall configuration of an information processing system 1 in an embodiment.

The information processing system 1 is configured to: display a bird’s-eye view on a display 23 of an information terminal 20; display, in the bird’s-eye view, a photographing spot icon group indicating a plurality of photographing spots being continuous in a series from a photographing start spot to a photographing finish spot; receive, in the bird’s-eye view, selection of a certain region by the user; and, extracting, in a case where the certain region includes two or more photographing spot icon groups and respective photographing positions for the two or more photographing spot icon groups are similar to each other, two or more pieces of data for the two or more photographing spot icon groups similar to each other. The information processing system 1 includes a server 10, the information terminal 20, a photographing device 30, and a communication device 40.

The server 10 is an example of an information processing device and a computer. The server 10, the information terminal 20, and the communication device 40 are communicably connected to one another via a network NT. The network NT includes, for example, the internet. The server 10 includes, for example, a cloud server including one or more computers. However, this is a mere example, and the server 10 may include an edge server, or may be mounted to the information terminal 20. A configuration in which the server 10 is mounted to the information terminal 20 corresponds to an example configuration of the information terminal 20 in the form of an information processing device.

The information terminal 20 is carriable by a user. The user is, for example, a manager of a predetermined space to be photographed by the photographing device 30. The predetermined space is, for example, a construction site. However, this is a mere example, and the predetermined space may be a worksite, a factory, a shop or store, or an office. The information terminal 20 may include a portable computer, e.g., a smartphone or a tablet computer, or may include a stationary computer. The information terminal 20 is configured to display an image on the display 23 under control by the server 10. Although FIG. 1 shows an example of one information terminal 20, a plurality of information terminals may be connected to the server 10 via the network NT. The information terminal 20 includes a communication part 21, a processor 22, the display 23, and a manipulation part 24.

The communication part 21 includes a communication interface that connects the information terminal 20 to the network NT. The communication part 21 is configured to send, to the server 10, instruction signals respectively indicating various instructions which the manipulation part 24 receives from the user. The communication part 21 is configured to receive, from the server 10, display data to display various display screen images.

The processor 22 includes, for example, a central processing unit (CPU), and causes the display 23 to display a display screen image indicated by the display data received by the communication part 21.

The display 23 includes, for example, various display devices, e.g., liquid crystal displays or organic Electro-Luminescence (EL) displays, to display various display screen images under control by the processor 22.

The manipulation part 24 includes, for example, a keyboard, a touch screen, and a mouse, and is configured to receive various instructions input by the user.

The communication device 40 includes a mobile information terminal, e.g., a smartphone or a tablet computer, and connects the photographing device 30 to the network NT. The communication device 40 and the photographing device 30 are communicably connected to each other via a near field wireless communication channel, such as the Bluetooth (registered trademark) and a wireless Local Area Network (LAN).

The photographing device 30 includes, for example, an omnidirectional camera, and captures an image at a predetermined frame rate. The omnidirectional camera is also referred to as a 360-degree camera and can acquire an omnidirectional image at 360 degrees. The photographing device 30 is, for example, a portable photographing device carriable by a photographing person. The photographing person is, for example, a worker or a site supervisor on a construction site. The photographing device 30 may execute photographing in a state of being held in a hand of the photographing person or in a state of being attached to a body (e.g., the head) of the photographing person. The photographing device 30 may include a typical camera.

The photographing person moves on the construction site while photographing the construction site with the photographing device 30. The photographing person presses, at a photographing start spot, a photographing button of the photographing device 30 while making a photographing direction of the photographing device 30 agree with a predetermined direction to start photographing, and presses the photographing button again to finish the photographing when reaching a photographing finish spot. The predetermined direction indicates a direction for agreement with a direction in a design drawing displayed on the display 23. The predetermined direction is, for example, the north direction, but the predetermined direction is not limited to the north direction. When the photographing is finished, the photographing device 30 sends a series of images having been captured to the communication device 40.

Each image includes a photographing date and time. For instance, the photographing date and time is acquired by a timepiece included in the photographing device 30. Here, the photographing device 30 is configured to capture an image at a predetermined frame rate (e.g., ten frames per second), and therefore, a photographing spot is defined by a frame periodic unit. However, this leads to a huge amount of data, and thus, the photographing spot may be defined for a predetermined time period (e.g., one second, five seconds, or ten seconds).

The communication device 40 is configured to receive the images sent from the photographing device 30. The communication device 40 is further configured to display a design drawing for the construction site, and receive designation by the photographing person about a position corresponding to the photographing start spot and a position corresponding to the photographing finish spot in the design drawing.

The photographing start spot and the photographing finish spot are specified in response to input of instruction from the photographing person to designate the position corresponding to each spot in a design drawing screen image of a site displayed on a display of the communication device 40. A two-dimensional coordinate axis is defined in the design drawing screen image. Thus, each of the photographing start spot and the photographing finish spot is defined by a two-dimensional coordinate value. The server 10 uses each of the photographing start spot and the photographing finish spot to specify a position corresponding to each photographing spot and a photographing direction for each image.

The communication device 40 sends, to the server 10 via the network NT, photographing information including the captured images. The photographing information is generated at every execution of one photographing operation. The one photographing operation means a series of actions from start of photographing to finish of the photographing by a worker carrying the photographing device 30 on the construction site. A plurality of images is captured through the one photographing operation. The photographing information includes the captured images and meta information about each of the images. The meta information includes a photographing ID, a photographing date and time, and a design drawing ID. The photographing ID is an identifier to identify a photographing operation. The photographing date and time represents a photographing date and time for each image. The design drawing ID is an identifier to identify a design drawing for a predetermined space corresponding to an image.

The server 10 includes a processor 11, a memory 12, and a communication part 13. The processor 11 includes, for example, a central processing unit (CPU). The processor 11 includes an acquisition part 111, a selection receiving part 112, a display control part 113, and an extraction part 114. Each of the acquisition part 111, the selection receiving part 112, the display control part 113, and the extraction part 114 may come into effect, for example, when the processor 11 executes an information processing program, or may be established in the form of a dedicated hardware circuit, such as an application specific integrated circuit (ASIC). The information processing program may be recorded in a non-transitory computer-readable recording medium.

The communication part 13 includes a communication interface that connects the server 10 to the network NT. The communication part 13 is configured to receive the photographing information sent from the communication device 40. The communication part 13 is configured to receive from the information terminal 20, instruction signals respectively indicating various instructions received from the user. The communication part 13 is configured to send to the information terminal 20, display data to display various display screen images.

The memory 12 includes a non-volatile and rewritable storage device, such as a hard disk drive or a solid-state drive. The memory 12 includes a design drawing information storage part 121 and a photographing tracking data storage part 122.

The design drawing information storage part 121 stores design drawing information. The design drawing information includes image information indicating a design drawing for a predetermined space. The design drawing information is associated with a design drawing ID to identify the design drawing. The design drawing is an example of a bird’s-eye view. The design drawing represents a drawing of a design for a construction site, and may include a plan view, a blueprint, a map, or a perspective view of the construction site. The bird’s-eye view can be rephrased as an overhead view, that is, a view seen from above, or a view from a high position looking down. In a case where a construction site has a plurality of floors, the design drawing information includes a design drawing for each of the floors.

The acquisition part 111 is configured to specify, by employing the Visual Simultaneous Localization and Mapping (SLAM) technique, a position corresponding to a photographing spot for each of the images from a photographing start spot, a photographing finish spot, and the images each included in the photographing information received by the communication part 13. Such a position corresponding to the photographing spot is expressed with a two-dimensional coordinate value in the design drawing. The acquisition part 111 further specifies a photographing direction for each of the images by employing the Visual SLAM technique. The photographing direction for each image is expressed with, for example, a three-dimensional polar coordinate vector.

The photographing tracking data storage part 122 stores a plurality of pieces of photographing tracking data. The photographing tracking data associates a plurality of captured images having been captured respectively at a plurality of photographing spots being continuous in a series from a photographing start spot to a photographing finish spot, a photographing ID, a photographing start date and time, a design drawing ID, and a registrant ID with one another. The registrant ID is information to identify a registrant who has registered the photographing tracking data in the photographing tracking data storage part 122. The registrant is, for example, a photographing person. The photographing tracking data is generated at every receipt of the photographing information. The captured image includes meta information. The meta information includes a photographing ID, a photographing date and time, a photographing direction, a photographing spot, and a design drawing ID. The photographing direction represents a photographing direction in which the photographing device 30 has captured each image. The photographing spot represents positional information (a two-dimensional coordinate value) indicating the photographing spot for each image.

The communication part 13 is configured to receive, from the information terminal 20, an instruction to designate a floor of the construction site. The manipulation part 24 of the information terminal 20 receives selection of the floor of the construction site by the user, and the communication part 21 sends, to the server 10, an instruction to designate the floor of the construction site selected by the user.

The acquisition part 111 acquires from the design drawing information storage part 121, a design drawing corresponding to the floor of the construction site and contained in the instruction to designate the floor of the construction site received by the communication part 13. The acquisition part 111 acquires from the photographing tracking data storage part 122, photographing tracking data associated with the design drawing ID of the acquired design drawing.

The display control part 113 is configured to cause the display 23 of the information terminal 20 to display a design drawing corresponding to a predetermined space. The display control part 113 causes the display 23 of the information terminal 20 to display the design drawing acquired by the acquisition part 111. The display control part 113 is configured to send display data for the design drawing to the information terminal 20 via the communication part 13. The communication part 21 of the information terminal 20 receives the display data sent from the server 10. The display 23 displays the design drawing received by the communication part 21.

The display control part 113 is configured to display, in the design drawing, a photographing spot icon group indicating a plurality of photographing spots being continuous in a series from a photographing start spot to a photographing finish spot. The photographing spot icon group is associated with a plurality of images captured at the photographing spots. The display control part 113 is configured to display, in the design drawing, the photographing spot icon group on the basis of the photographing tracking data acquired by the acquisition part 111. In a case where a plurality of pieces of photographing tracking data is associated with the design drawing, the display control part 113 displays a plurality of photographing spot icon groups in the design drawing.

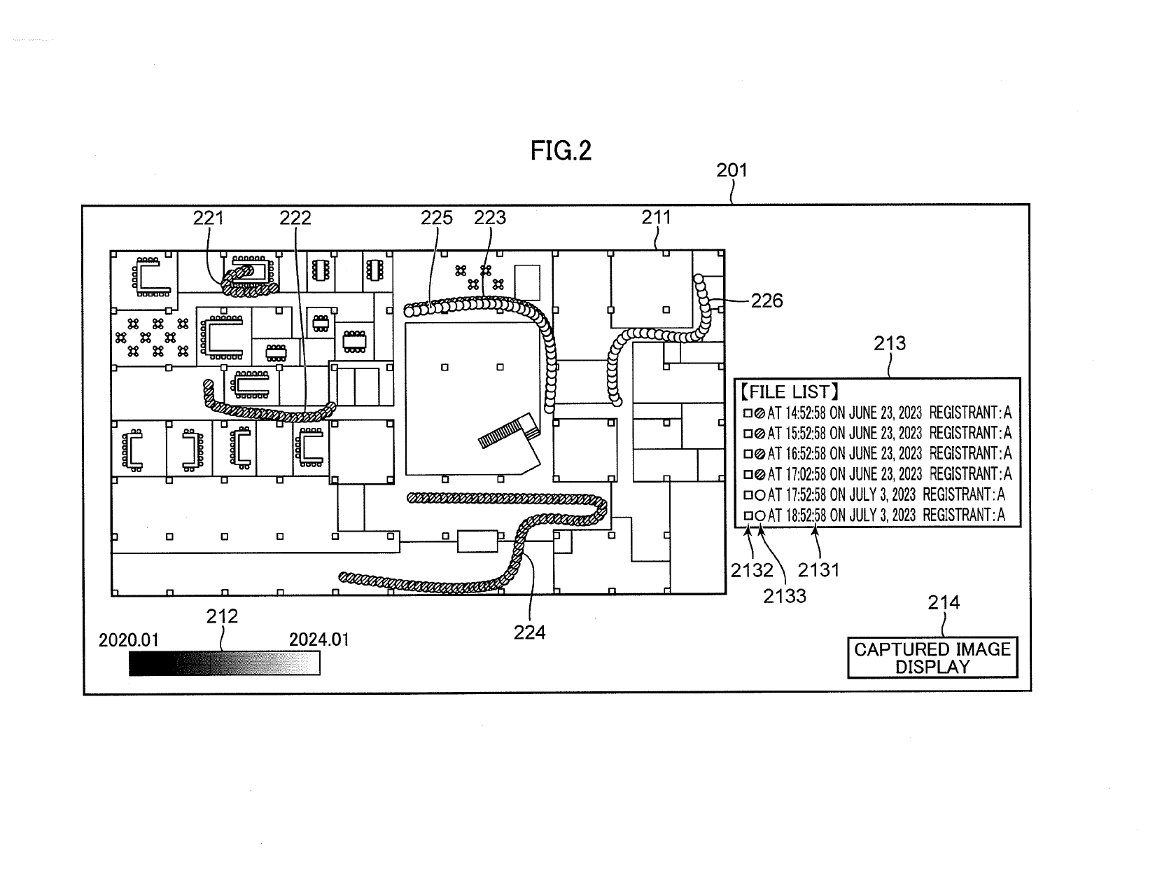

FIG. 2 illustrates an example design drawing screen image 201 in which a plurality of photographing spot groups is mapped in the embodiment. The design drawing screen image 201 shows a design drawing 211 for a predetermined floor of a predetermined construction site, a color bar 212 showing a correlation between a photographing date and time and a color, a list display field 213, and a captured image display button 214. In the design drawing 211, a plurality of photographing spot icon groups 221, 222, 223, 224, 225, and 226 is superimposed and displayed.

The photographing spot icon group 221 is a collection of photographing spot icons respectively indicating a plurality of photographing spots being continuous in a series from a photographing start spot to a photographing finish spot. One photographing spot icon is associated with one captured image captured at one photographing spot. In this example, the photographing spot icon includes an image having a circular shape with a predetermined dimension. The photographing spot icon group 221 displayed here indicates a plurality of photographing spots belonging to one certain photographing operation. A route from a photographing spot icon indicating a photographing start spot to a photographing spot icon indicating a photographing finish spot shows a trace followed by the photographing person in the photographing operation. It is noted here that each of the remaining photographing spot icon groups 222, 223, 224, 225, and 226 is equivalent to the photographing spot icon group 221.

The photographing device 30 captures an image at a predetermined frame rate. In this configuration, the number of images is expressed with “frame rate (fps) * photographing time (sec.)”. FIG. 2 shows a plurality of photographing spot icons displayed in an overlapping manner along the trace followed by the photographing person. In the route from the photographing start spot to the photographing finish spot, newer photographing spot icons overlap older ones thereon one after another.

The photographing spot icon groups 221, 222, 223, 224, 225, and 226 have their respective photographing dates and times (photographing start dates and times) different from one another. The display control part 113 is configured to display each of the photographing spot icon groups 221, 222, 223, 224, 225, and 226 in a color in connection with the photographing date and time. FIG. 2 shows each of the photographing spot icon groups 221, 222, 223, 224, 225, and 226 displayed in a different color per photographing date. For instance, each of the photographing spot icon groups 221, 222, 223, and 224 indicates a plurality of photographing spots related to photographing on June 23, 2023, and each of the photographing spot icon groups 225 and 226 indicates a plurality of photographing spots related to photographing on July 3, 2023. A photographing date for a photographing spot icon group can be specified from a color of the photographing spot icon group and the color bar 212.

In a case where a plurality of photographing spot icon groups overlaps, a photographing spot icon group having a later photographing date and time is displayed on another photographing spot icon group having an earlier photographing date and time. For instance, the first photographing spot icon group 223 has a photographing date and time “at 17:02:58 on June 23, 2023”, and the second photographing spot icon group 225 has a photographing date and time “at 17:52:58, on July 3, 2023”. Thus, the second photographing spot icon group 225 is displayed on the first photographing spot icon group 223.

The list display field 213 includes names 2131 to each identify an associated photographing spot icon group, checkboxes 2132 to each select an associated photographing spot icon group and photographing spot icons 2133. Each name 2131 is expressed with a photographing date and time and a name of a registrant. The photographing date and time represent, for example, a photographing start date and time. The names 2131 in the list display field 213 show names of the photographing spot icon groups 221, 222, 223, 224, 225, and 226 in order from the top. The user presses a certain checkbox 2132 located to the left of an associated photographing spot icon group for a captured image to be displayed. In response to the pressing of the checkbox 2132, the display control part 113 changes a display state of the checkbox 2132 to a state of being checked.

The captured image display button 214 is a button to display a captured image. When the captured image display button 214 is pressed, the display control part 113 displays a captured image for a photographing spot icon group selected through the checkbox 2132.

The selection receiving part 112 is configured to receive, in the design drawing, selection of a certain region by the user.

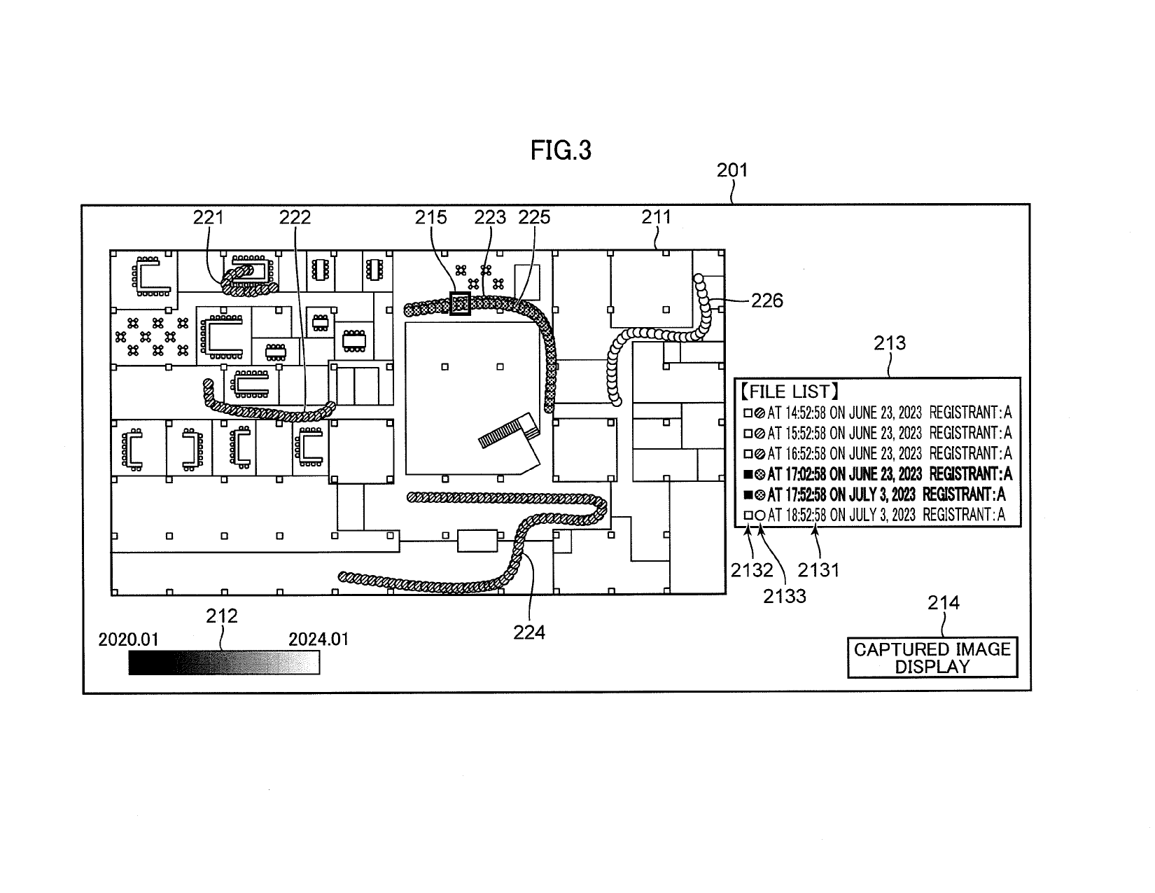

FIG. 3 illustrates an example design drawing screen image 201 showing a design drawing 211 in which a region 215 is drawn.

The selection receiving part 112 receives, in the design drawing 211, selection of the certain region 215 by the user. The region 215 has, for example, a rectangular shape. The selection receiving part 112 receives a manipulation of dragging a mouse by the user. The user selects the region 215 having the rectangular shape by dragging the mouse. In this case, the display 23 is configured to draw the region 215 having the rectangular shape in the design drawing 211, the rectangular shape having a diagonal defined by a straight line connecting a point to start dragging the mouse and a point to finish dragging the mouse to each other.

In selection of a photographing spot icon group for a captured image to be displayed, the user selects the region 215 including the photographing spot icon group. FIG. 3 shows selection of the region 215 including a part of each of the photographing spot icon groups 223, 225.

The selection receiving part 112 may receive a manipulation of clicking the mouse by the user. The user selects the region 215 having the rectangular shape by clicking the mouse. In this case, the display 23 may be configured to draw, in the design drawing 211, the region 215 having a circular shape or a rectangular shape with a predetermined dimension and the center at the point where the mouse is clicked.

The display control part 113 is configured to determine whether the region includes two or more photographing spot icon groups. In a case where the region includes two or more photographing spot icon groups, the display control part 113 is configured to determine whether respective photographic positions for the two or more photographing spot icon groups are similar to each other. The display control part 113 determines that the respective photographing positions for the two or more photographing spot icon groups are similar to each other when at least one of a distance between photographing start spots respectively for the two or more photographing spot icon groups and a distance between photographing finish spots respectively for the two or more photographing spot icon groups has a threshold or lower.

Specifically, FIG. 3 illustrates two or more photographing spot icon groups including the first photographing spot icon group 223 and the second photographing spot icon group 225 within the region 215. The display control part 113 determines that a photographing position for the first photographing spot icon group 223 and a photographing position for the second photographing spot icon group 225 are similar to each other when at least one of a distance between a photographing start spot for the first photographing spot icon group 223 and a photographing start spot for the second photographing spot icon group 225 and a distance between a photographing finish spot for the first photographing spot icon group 223 and a photographing finish spot for the second photographing spot icon group 225 has a threshold or lower.

In the case where the region includes the two or more photographing spot icon groups and the respective photographing positions for the two or more photographing spot icon groups are similar to each other, the extraction part 114 extracts two or more pieces of data for the two or more photographing spot icon groups similar to each other. Here, the extracted data includes a captured image captured at a certain photographing spot.

Specifically, in FIG. 3, the extraction part 114 extracts first data for the first photographing spot icon group 223 and second data for the second photographing spot icon group 225 when at least one of the distance between the photographing start spot for the first photographing spot icon group 223 and the photographing start spot for the second photographing spot icon group 225 and the distance between the photographing finish spot for the first photographing spot icon group 223 and the photographing finish spot for the second photographing spot icon group 225 has the threshold or lower. Here, each of the extracted first data and the extracted second data includes a captured image.

In the example in FIG. 3, the distance between the photographing start spot for the first photographing spot icon group 223 and the photographing start spot for the second photographing spot icon group 225 has the threshold or lower, and the distance between the photographing finish spot for the first photographing spot icon group 223 and the photographing finish spot for the second photographing spot icon group 225 has the threshold or lower.

The display control part 113 causes the display 23 to display a name 2131 to identify a photographing spot icon group together with the design drawing 211. The display control part 113 is configured to change, in the case where the region includes the two or more photographing spot icon groups and the respective photographing positions for the two or more photographing spot icon groups are similar to each other, a display mode for the two or more photographing spot icon groups and a display mode for two or more names corresponding to the two or more photographing spot icon groups. For instance, the display control part 113 changes a color of the two or more photographing spot icon groups, and changes a color of the two or more names to the same color as the changed color of the two or more photographing spot icon groups.

In the example in FIG. 3, the display control part 113 changes the color of the first photographing spot icon group 223 and the second photographing spot icon group 225 to red, and changes the color of the name of the first photographing spot icon group 223 and the name of the second photographing spot icon group 225 to red that is the same color as the changed color of each of the first photographing spot icon group 223 and the second photographing spot icon group 225. The list display field 213 shows the name of the first photographing spot icon group 223 as “at 17:02:58 on June 23, 2023, Registrant: A”, and the name of the second photographing spot icon group 225 as “at 17:52:58, on July 3, 2023, Registrant: A”. FIG. 3 shows the change in the color of the name of the first photographing spot icon group 223 and the name of the second photographing spot icon group 225 with the characters of the names in bold. The color of the photographing spot icons 2133 in the list display field 213 is also changed as well as the color of the names.

The display control part 113 further causes the display 23 to display two or more captured images extracted by the extraction part 114. The display control part 113 is configured to send display data for the two or more captured images to the information terminal 20 via the communication part 13. The communication part 21 of the information terminal 20 receives the display data sent from the server 10. The display 23 displays the two or more captured images received by the communication part 21.

In the example in FIG. 3, the manipulation part 24 of the information terminal 20 receives input by the user about the checkboxes 2132 respectively for the first photographing spot icon group 223 and the second photographing spot icon group 225 to each display an associated captured image. The user inputs a check mark in each of the checkboxes 2132 respectively for the first photographing spot icon group 223 and the second photographing spot icon group 225 to each display the associated captured image and thereby selects the first photographing spot icon group 223 and the second photographing spot icon group 225 to each display the associated captured image. When the captured image display button 214 is pressed by the user, the communication part 21 sends, to the server 10, information about the first photographing spot icon group 223 and the second photographing spot icon group 225 selected by the user. The communication part 13 receives from the information terminal 20, the information about the first photographing spot icon group 223 and the second photographing spot icon group 225 selected by the user.

The extraction part 114 extracts a captured image for the selected first photographing spot icon group 223 and a captured image for the selected second photographing spot icon group 225. The display control part 113 causes the display 23 to display the captured image for the first photographing spot icon group 223 and the captured image for the second photographing spot icon group 225, each captured image having been extracted by the extraction part 114.

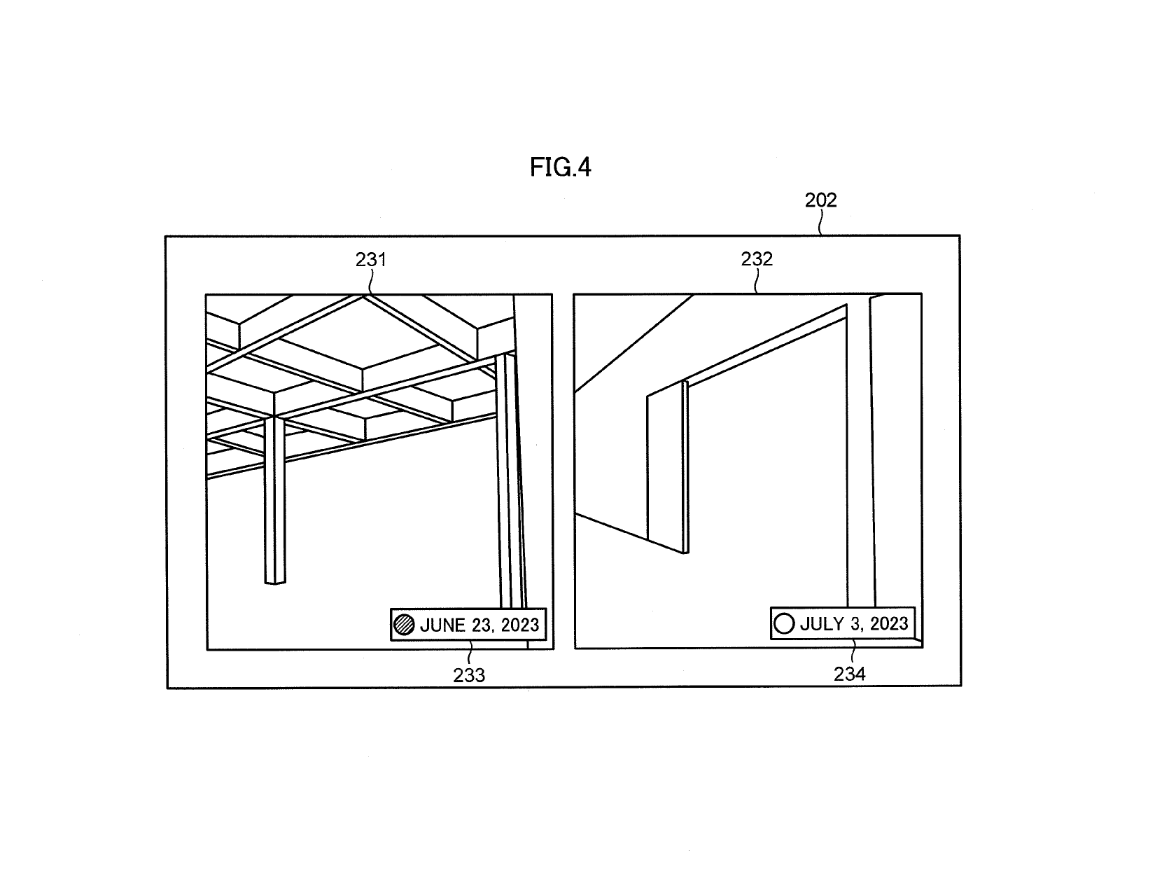

FIG. 4 illustrates an example captured image screen image 202 to be displayed on the display 23 when the region 215 is selected in the embodiment.

The captured image screen image 202 shows a captured image 231 captured at a photographing spot corresponding to one photographing spot icon in the first photographing spot icon group 223, and a captured image 232 captured at a photographing spot corresponding to one photographing spot icon in the second photographing spot icon group 225. The extraction part 114 is configured to extract, from the photographing tracking data storage part 122, a captured image 231 captured at a photographing spot corresponding to a photographing icon having the earliest photographing date and time in the first photographing spot icon group 223 within the region 215, and extract, from the photographing tracking data storage part 122, a captured image 232 captured at a photographing spot corresponding to a photographing spot icon having the earliest photographing date and time in the second photographing spot icon group 225 within the region 215. The display control part 113 causes the display 23 to display the captured image 231 and the captured image 232 extracted by the extraction part 114.

Here, the display control part 113 is configured to cause the display 23 to display each of the captured images 231, 232 having a rectangular shape cut out from an omnidirectional image in relation to a sightline direction. The sightline direction in the captured image 231 and the sightline direction in the captured image 232 are the same. The captured image screen image 202 includes a date field 233 showing a photographing spot icon and a photographing date, month, and year for the associated the captured image 231, and a date field 234 showing a photographing spot icon and a photographing date, month, and year for the associated the captured image 232.

The extraction part 114 is further configured to extract, from the photographing tracking data storage part 122, a captured image 231 captured at a photographing spot corresponding to a photographing icon having the latest photographing date and time in the first photographing spot icon group 223 within the region 215, and extract, from the photographing tracking data storage part 122, a captured image 232 captured at a photographing spot corresponding to a photographing spot icon having the latest photographing date and time in the second photographing spot icon group 225 within the region 215.

Although the data extracted by the extraction part 114 includes a captured image in the embodiment, the present disclosure is not particularly limited thereto. The data extracted by the extraction part 114 may include voice data collected at a photographing spot, or text information input at the photographing spot.

Next, an image displaying process by the server 10 in the embodiment will be described.

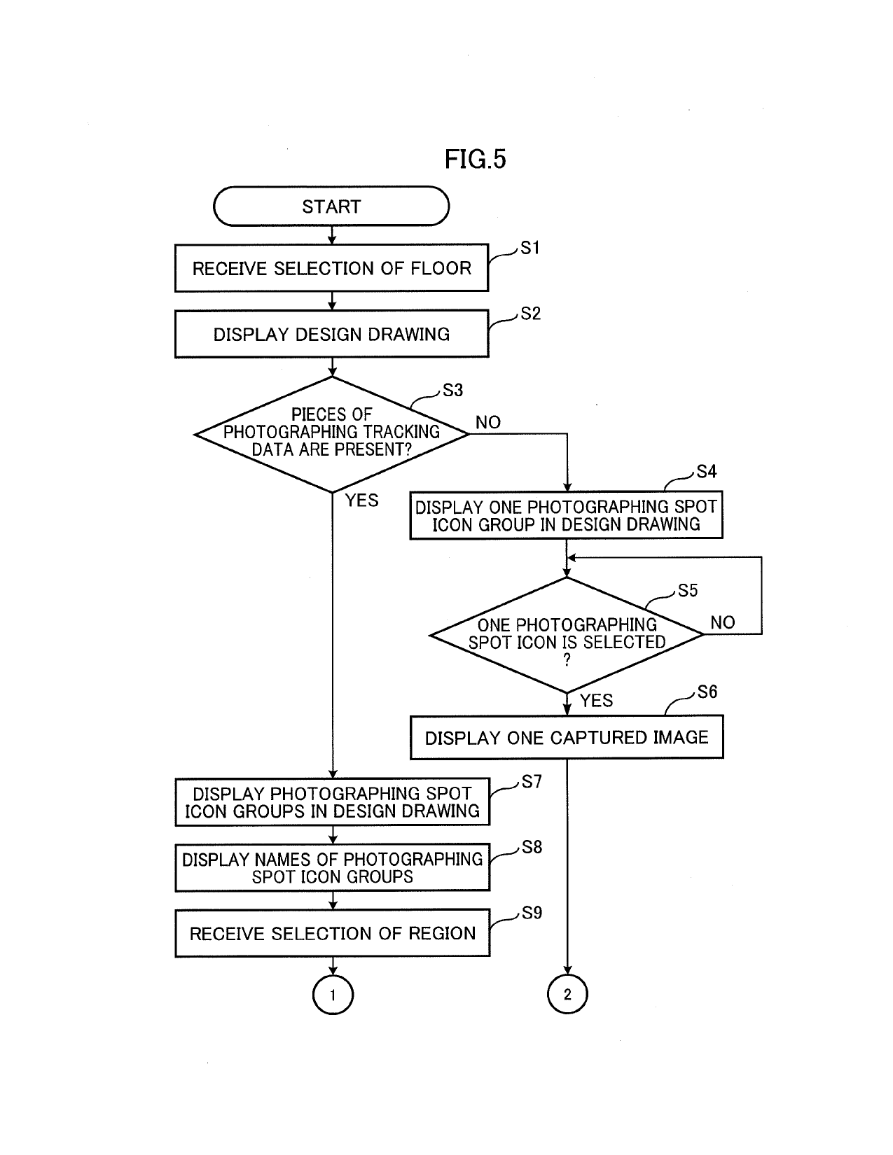

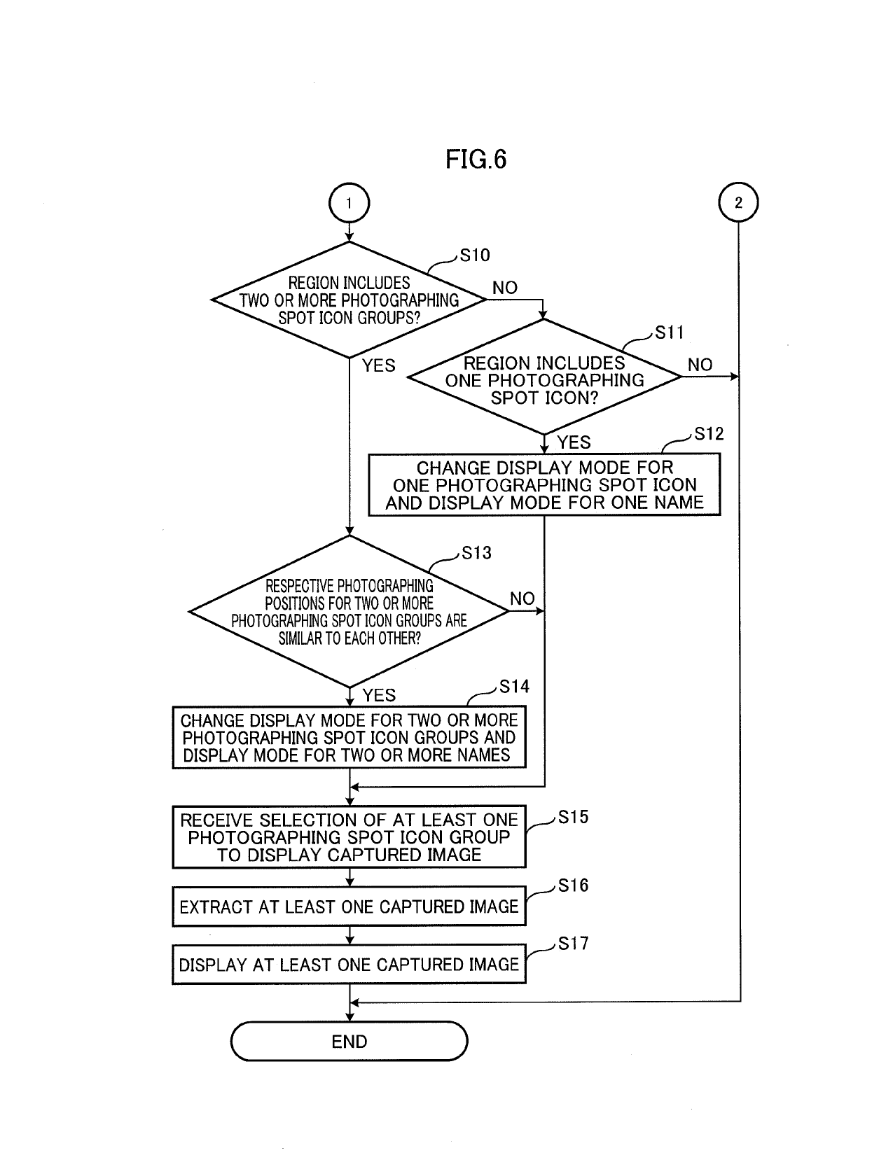

FIG. 5 is a first flowchart showing an example of the image displaying process by the server 10 in the embodiment. FIG. 6 is a second flowchart showing an example of the image displaying process by the server 10 in the embodiment.

First, in step S1, the selection receiving part 112 receives selection of a floor of a construction site by a user. The display control part 113 causes the display 23 to display a floor selection screen image to receive selection of one floor from among a plurality of floors of the construction site. The floor selection screen image shows a name of the construction site and a plurality of floor names which are selectable. The manipulation part 24 of the information terminal 20 receives selection of the name of the construction site and a floor name of the construction site by the user. The user selects one floor name from among the floor names. The communication part 21 sends, to the server 10, an instruction to designate the floor of the construction site selected by the user. The communication part 13 receives, from the information terminal 20, the instruction to designate the floor of the construction site.

Subsequently, in step S2, the display control part 113 causes the display 23 to display a design drawing corresponding to the floor selected by the user. The acquisition part 111 acquires from the design drawing information storage part 121, a design drawing corresponding to the floor of the construction site and contained in the instruction to designate the floor of the construction site received by the communication part 13. The display control part 113 causes the display 23 to display the design drawing acquired by the acquisition part 111.

Then, in step S3, the display control part 113 determines whether a plurality of pieces of photographing tracking data that is associated with the selected design drawing is present. The acquisition part 111 acquires from the photographing tracking data storage part 122, at least one piece of photographing tracking data associated with a design drawing ID of the acquired design drawing and acquired through photographing on a different date and time.

When it is determined that a plurality of pieces of photographing tracking data is not present (NO in step S3), the display control part 113 displays, in step S4, one photographing spot icon group in the design drawing on the basis of the one piece of acquired photographing tracking data. The one photographing spot icon group is selectively displayed. The display control part 113 sends, to the information terminal 20 via the communication part 13, display data for the one photographing spot icon group indicating a plurality of photographing spots being continuous in a series from a photographing start spot to a photographing finish spot for each of captured images included in the one piece of photographing tracking data. The communication part 21 of the information terminal 20 receives the display data sent from the server 10. The display 23 displays the one photographing spot icon group received by the server 10.

Next, in step S5, the display control part 113 determines whether one photographing spot icon in the one photographing spot icon group being displayed is selected. The manipulation part 24 of the information terminal 20 is configured to receive selection of one photographing spot icon in the one photographing spot icon group by the user. The user selects one photographing spot icon in the one photographing spot icon group. The communication part 21 sends, to the server 10, an instruction to designate the one photographing spot icon selected by the user. The communication part 13 receives, from the information terminal 20, the instruction to designate the one photographing spot icon.

When it is determined that one photographing spot icon is not selected (NO in step S5), the determination in step S5 is repeated until one photographing spot icon is selected.

In contrast, when it is determined that one photographing spot icon is selected (YES in step S5), the display control part 113 causes, in step S6, the display 23 to display one captured image corresponding to the selected one photographing spot icon. The photographing spot icon indicates a photographing spot in the design drawing. The display control part 113 is configured to display one captured image captured at one photographing spot corresponding to one photographing spot icon. Specifically, the display control part 113 sends display data for the one captured image to the information terminal 20 via the communication part 13. In the information terminal 20, the processor 22 causes the display 23 to display the display data received by the communication part 21. In this way, the display 23 displays the one captured image.

It is noted here that the display control part 113 may finish the image displaying process in absence of photographing tracking data associated with the selected design drawing.

In contrast, when it is determined that a plurality of pieces of photographing tracking data is present (YES in step S3), the display control part 113 displays, in the design drawing, a plurality of photographing spot icon groups on the basis of the acquired pieces of photographing tracking data, in step S7. The display control part 113 sends, to the information terminal 20 via the communication part 13, display data for the photographing spot icon groups each indicating a plurality of photographing spots being continuous in a series from a photographing start spot to a photographing finish spot for each of captured images included in the pieces of photographing tracking data. The communication part 21 of the information terminal 20 receives the display data sent from the server 10. The display 23 displays the photographing spot icon groups received by the communication part 21.

Subsequently, in step S8, the display control part 113 displays respective names of the photographing spot icon groups together with the design drawing. The display control part 113 displays, together with checkboxes, the names of the photographing spot icon groups displayed in the design drawing.

Then, in step S9, the selection receiving part 112 receives selection of a certain region in the design drawing by the user. The manipulation part 24 of the information terminal 20 is configured to receive selection of a certain region in the design drawing by the user. The user here selects such a region having a rectangular shape in the design drawing. The communication part 21 sends, to the server 10, information to specify the region selected by the user. The information to specify the region includes coordinates of four vertices of the rectangular shape defining the region. The communication part 13 receives from the information terminal 20, the information to specify the region.

Next, in step S10, the display control part 113 determines whether the region selected by the selection receiving part 112 includes two or more photographing spot icon groups.

When it is determined that the region does not include two or more photographing spot icon groups (NO in step S10), the display control part 113 determines, in step S11, whether the region selected by the selection receiving part 112 includes one photographing spot icon group. Here, when it is determined that the region does not include one photographing spot icon group (NO in step S11), the process is finished.

In contrast, when it is determined that the region includes one photographing spot icon group (YES in step S11), the display control part 113 changes, in step S12, a display mode for the one photographing spot icon group and a display mode for one name corresponding to the one photographing spot icon group. For instance, the display control part 113 changes a color of the one photographing spot icon group to another color different from a color of other photographing spot icon group and changes a color of the name to the same color as the changed color of the one photographing spot icon group.

When it is determined that the region includes two or more photographing spot icon groups (YES in step S10), the display control part determines, in step S13, whether respective photographing positions for the two or more photographing spot icon groups are similar to each other. At this time, the display control part 113 determines that the respective photographing positions for the two or more photographing spot icon groups are similar to each other when at least one of a distance between photographing start spots respectively for the two or more photographing spot icon groups and a distance between photographing finish spots respectively for the two or more photographing spot icon groups has a threshold or lower. Contrarily, the display control part 113 determines that the respective photographing positions for the two or more photographing spot icon groups are not similar to each other when each of the distance between the photographing start spots respectively for the two or more photographing spot icon groups and the distance between the photographing finish spots respectively for the two or more photographing spot icon groups does not have the threshold or lower.

Here, when it is determined that the respective photographing positions for the two or more photographing spot icon groups are not similar to each other (NO in step S13), the process proceeds to step S15.

In contrast, when it is determined that the respective photographing positions for the two or more photographing spot icon groups are similar to each other (YES in step S13), the display control part 113 changes, in step S14, a display mode for the two or more photographing spot icon groups and a display mode for two or more names corresponding to the two or more photographing spot icon groups. For instance, the display control part 113 changes a color of the two or more photographing spot icon groups within the region to another color different from a color for other photographing spot icon group located outside the region and changes a color of the two or more names to the same color as the changed color of the two or more photographing spot icon groups.

Subsequently, in step S15, the selection receiving part 112 receives selection of at least one photographing spot icon group to display a captured image. At this time, the manipulation part 24 of the information terminal 20 receives selection by the user about at least one photographing spot icon group to display a captured image. The user inputs a check mark in the checkbox for the name of the at least one photographing spot icon group to display the captured image, and thereby selects the at least one photographing spot icon group to display the captured image. When the captured image display button is pressed by the user, the communication part 21 sends, to the server 10, information about the at least one photographing spot icon group selected by the user. The communication part 13 receives, from the information terminal 20, the information about the at least one photographing spot icon group selected by the user.

In a case where the region includes two or more photographing spot icon groups and respective photographing positions for the two or more photographing spot icon groups are similar to each other, the selection receiving part 112 receives selection of the two or more photographing spot icon groups to each display a captured image. Alternatively, in a case where the region includes one photographing spot icon group, the selection receiving part 112 receives selection of the one photographing spot icon group to display a captured image.

Then, in step S16, the extraction part 114 extracts, from the photographing tracking data storage part 122, at least one captured image for the at least one photographing spot icon group selected by the user. At this time, the extraction part 114 extracts, from the photographing tracking data storage part 122, a captured image captured at a photographing spot corresponding to a photographing spot icon having the earliest photographing date and time in the photographing spot icon group within the region.

In the case where the region includes two or more photographing spot icon groups and respective photographing positions for the two or more photographing spot icon groups are similar to each other, the extraction part 114 extracts, from the photographing tracking data storage part 122, two or more captured images for the two or more photographing spot icon groups selected by the user. Alternatively, in the case where the region includes one photographing spot icon group, the extraction part 114 extracts, from the photographing tracking data storage part 122, one captured image for the one photographing spot icon group selected by the user.

Next, in step S17, the display control part 113 causes the display 23 to display the at least one captured image extracted by the extraction part 114. Specifically, the display control part 113 sends display data for the at least one captured image to the information terminal 20 via the communication part 13. In the information terminal 20, the processor 22 causes the display 23 to display the display data received by the communication part 21. In this way, the display 23 displays the at least one captured image.

In the case where the region includes two or more photographing spot icon groups and respective photographing positions for the two or more photographing spot icon groups are similar to each other, the display control part 113 causes the display 23 to display two or more captured images extracted by the extraction part 114. Alternatively, in the case where the region includes one photographing spot icon group, the display control part 113 causes the display 23 to display one captured image extracted by the extraction part 114.

This configuration enables easy access to two or more pieces of data for two or more desired photographing spot icon groups through selection of a region including the two or more desired photographing spot icon groups in a design drawing, and thus achieves improvement in convenience for a user. The configuration further includes extracting the two or more pieces of data for the two or more photographing spot icon groups through the selection of the region including the two or more desired photographing spot icon groups in the design drawing, and thus achieves a reduction in the number of processing steps required by a computer for the access to the two or more pieces of data, and then achieves a reduction in the burden on the computer.

In the embodiment, the display control part 113 determines whether at least one of a distance between photographing start spots respectively for two or more photographing spot icon groups and a distance between photographing finish spots respectively for the two or more photographing spot icon groups has a threshold or lower, and thereby determines whether respective photographing positions for the two or more photographing spot icon groups are similar to each other. However, the present disclosure is not particularly limited thereto.

In a first modification of the embodiment, the display control part 113 may determine whether two or more photographing spot icon groups overlap each other within a region and thereby determine whether respective photographing positions for the two or more photographing spot icon groups are similar to each other. In this configuration, the display control part 113 may determine, in step S13 in FIG. 6, that the respective photographing positions for the two or more photographing spot icon groups are similar to each other when the two or more photographing spot icon groups overlap each other within the region. In contrast, the display control part 113 may determine that the respective photographing positions for the two or more photographing spot icon groups are not similar to each other when the two or more photographing spot icon groups do not overlap each other within the region.

Specifically, in a case where a region includes two or more photographing spot icon groups, when the two or more photographing spot icon groups overlap each other within the region, the extraction part 114 may extract two or more pieces of data for the two or more photographing spot icon groups. Besides, in the case where the region includes the two or more photographing spot icon groups, when the two or more photographing spot icon groups overlap each other within the region, the display control part 113 may change a display mode for the two or more photographing spot icon groups and a display mode for two or more names corresponding to the two or more photographing spot icon groups.

In the example in FIG. 3, in a case where the region 215 includes the first photographing spot icon group 223 and the second photographing spot icon group 225, when the first photographing spot icon group 223 and the second photographing spot icon group 225 overlap each other within the region 215, the extraction part 114 may extract a captured image for the first photographing spot icon group 223 and a captured image for the second photographing spot icon group 225. In the case where the region 215 includes the first photographing spot icon group 223 and the second photographing spot icon group 225, when the first photographing spot icon group 223 and the second photographing spot icon group 225 overlap each other within the region 215, the display control part 113 may change the display mode for the first photographing spot icon group 223, the display mode for the second photographing spot icon group 225, the display mode for the name of the first photographing spot icon group 223, and the display mode for the name of the second photographing spot icon group 225.

In a second modification of the embodiment, the display control part 113 may determine whether a shortest distance among distances respectively between a plurality of photographing spots for a first photographing spot icon group within a region and a plurality of photographing spots for a second photographing spot icon group within the region has a threshold or lower, and thereby determine whether respective photographing positions for two or more photographing spot icon groups are similar to each other. In this configuration, the display control part 113 may determine, in step S13 in FIG. 6, that the respective photographing positions for the first photographing spot icon group and the second photographing spot icon group are similar to each other when the shortest distance among distances respectively between the photographing spots for the first photographing spot icon group within the region and the photographing spots for the second photographing spot icon group within the region has the threshold or lower. In contrast, the display control part 113 may determine that the respective photographing positions for the first photographing spot icon group and the second photographing spot icon group are not similar to each other when the shortest distance among the distances respectively between the photographing spots for the first photographing spot icon group within the region and the photographing spots for the second photographing spot icon group within the region does not have the threshold or lower.

Specifically, in a case where a region includes a first photographing spot icon group and a second photographing spot icon group, when a shortest distance among distances respectively between a plurality of photographing spots for the first photographing spot icon group within a region and a plurality of photographing spots for the second photographing spot icon group within the region has a threshold or lower, the extraction part 114 may extract first data for the first photographing spot icon group and second data for the second photographing spot icon group. Moreover, in the case where the region includes the first photographing spot icon group and the second photographing spot icon group, when a shortest distance among the distances respectively between the photographing spots for the first photographing spot icon group within the region and the photographing spots for the second photographing spot icon group within the region has the threshold or lower, the display control part 113 may change a display mode for the first photographing spot icon group, a display mode for the second photographing spot icon group, a display mode for the name of the first photographing spot icon group, and a display mode for the name of the second photographing spot icon group.

In the example in FIG. 3, in a case where the region 215 includes the first photographing spot icon group 223 and the second photographing spot icon group 225, when a shortest distance among distances respectively between the photographing spots for the first photographing spot icon group 223 within the region 215 and the photographing spots for the second photographing spot icon group 225 within the region 215 has a threshold or lower, the extraction part 114 may extract a captured image for the first photographing spot icon group 223 and a captured image for the second photographing spot icon group 225. Moreover, in the case where the region 215 includes the first photographing spot icon group 223 and the second photographing spot icon group 225, when the shortest distance among the distances respectively between the photographing spots for the first photographing spot icon group 223 within the region 215 and the photographing spots for the second photographing spot icon group 225 within the region 215 has the threshold or lower, the display control part 113 may change a display mode for the first photographing spot icon group 223, a display mode for the second photographing spot icon group 225, a display mode for the name of the first photographing spot icon group 223, and a display mode for the name of the second photographing spot icon group 225.

A part of or a whole of the functions of the device according to each embodiment of the present disclosure may be implemented by a processor, such as a CPU executing a program.

Numerical values used above are merely illustrative to be used to specifically describe the present disclosure, and thus the present disclosure is not limited to the illustrative numerical values.

Order in which steps shown in the flowcharts are executed is merely illustrative to be used to specifically describe the present disclosure, and thus steps may be executed in order other than the above order as long as similar effects are obtained. Some of the steps may be executed simultaneously with (in parallel to) other steps.

The technology according to this disclosure enables easy access to two or more pieces of data for two or more desired photographing spot icon groups and achieves improvement in convenience for a user, and thus is useful as a technology to display an image.

1. An information processing method to be executed by a computer, comprising:
displaying a bird’s-eye view on a display of an information terminal;
displaying, in the bird’s-eye view, a photographing spot icon group indicating a plurality of photographing spots being continuous in a series from a photographing start spot to a photographing finish spot;
receiving, in the bird’s-eye view, selection of a certain region by the user; and
extracting, in a case where the certain region includes two or more photographing spot icon groups and respective photographing positions for the two or more photographing spot icon groups satisfy a predetermined positional similarity condition, two or more pieces of data for the two or more photographing spot icon groups satisfying the predetermined positional similarity condition.

2. The information processing method according to claim 1, wherein
the extracting of the two or more pieces of data includes extracting the two or more pieces of data for the two or more photographing spot icon groups when at least one of a distance between photographing start spots respectively for the two or more photographing spot icon groups and a distance between photographing finish spots respectively for the two or more photographing spot icon groups has a threshold or lower.

3. The information processing method according to claim 1, wherein
the extracting of the two or more pieces of data includes extracting the two or more pieces of data for the two or more photographing spot icon groups when the two or more photographing spot icon groups overlap each other within the certain region.

4. The information processing method according to claim 1, wherein
the two or more photographing spot icon groups include a first photographing spot icon group and a second photographing spot icon group, and
the extracting of the two or more pieces of data includes extracting first data for the first photographing spot icon group and second data for the second photographing spot icon group when a shortest distance among distances respectively between a plurality of photographing spots for the first photographing spot icon group within the certain region and a plurality of photographing spots for the second photographing spot icon group within the certain region has a threshold or lower.

5. The information processing method according to claim 1, further comprising
displaying, on the display, a name to identify the photographing spot icon group together with the bird’s-eye view.

6. The information processing method according to claim 5, further comprising
changing, in the case where the certain region includes the two or more photographing spot icon groups and the respective photographing positions for the two or more photographing spot icon groups are similar to each other, a display mode for the two or more photographing spot icon groups and a display mode for two or more names corresponding to the two or more photographing spot icon groups.

7. The information processing method according to claim 6, wherein
the changing of each of the display modes includes changing a color of the two or more photographing spot icon groups, and changing a color of the two or more names to the same color as the changed color of the two or more photographing spot icon groups.

8. The information processing method according to claim 1, wherein
the data includes an image captured at a certain photographing spot.

9. The information processing method according to claim 1, wherein
the displaying of the photographing spot icon group includes displaying the photographing spot icon group in a color in connection with a photographing date and time.

10. An information processing device, comprising
a processor,
the processor being configured to:
display a bird’s-eye view on a display of an information terminal;
display, in the bird’s-eye view, a photographing spot icon group indicating a plurality of photographing spots being continuous in a series from a photographing start spot to a photographing finish spot;
receive, in the bird’s-eye view, selection of a certain region by the user; and
extract, in a case where the certain region includes two or more photographing spot icon groups and respective photographing positions for the two or more photographing spot icon groups satisfy a predetermined positional similarity condition, two or more pieces of data for the two or more photographing spot icon groups satisfying the predetermined positional similarity condition.

11. A non-transitory computer readable recording medium storing an information processing program, comprising
causing a computer to:
display a bird’s-eye view on a display of an information terminal;
display, in the bird’s-eye view, a photographing spot icon group indicating a plurality of photographing spots being continuous in a series from a photographing start spot to a photographing finish spot;
receive, in the bird’s-eye view, selection of a certain region by the user; and
extract, in a case where the certain region includes two or more photographing spot icon groups and respective photographing positions for the two or more photographing spot icon groups satisfy a predetermined positional similarity condition, two or more pieces of data for the two or more photographing spot icon groups satisfying the predetermined positional similarity condition.
